(19) United States
(12) Patent Application Publication
(10) Pub. No.: US 2011/0204296 A1
(43) Pub. Date: Aug. 25, 2011

(54) METHOD FOR PRODUCING COMPOSITE MATERIALS HAVING REDUCED RESISTANCE AND COMPRISING CARBON NANOTUBES

(75) Inventors: Carsten Conzen, Leverkusen (DE); Michael Bierdel, Leverkusen (DE); Udo Dünger, Leverkusen (DE); Maren Heinemann, Bergisch-Gladbach (DE); Thomas König, Leverkusen (DE); Björn Walter, Stuttgart (DE); Jörg Metzger, Püttlingen (DE); Peter Heidemeyer, Kornwestheim (DE); Werner Wiedmann, Stuttgart (DE)

(73) Assignee: Bayer MaterialScience AG, Leverkusen (DE)

(21) Appl. No.: 13/059,899

(22) PCT Filed: Aug. 7, 2009
(86) PCT No.: PCT/EP2009/005731

§ 371 Date: Apr. 6, 2011

(30) Foreign Application Priority Data
Aug. 20, 2008 (DE) 10 2008 038 523.9

(51) Int. Cl. H01B 1/04; B82Y 30/00; B82Y 40/00

(52) U.S. Cl. 252/502; 977/742; 977/786; 977/840

(57) ABSTRACT

The present invention relates to a process for producing a composite having a reduced electrical resistance which comprises providing a mixture comprising a fluid material and carbon nanotubes (CNTs) having a predeterminable size distribution, and subjecting the mixture to a minimum stress in a dispersing machine, wherein the minimum stress is determined empirically as a function of the predetermined size distribution.

The invention relates to a process for producing a composite which has a reduced surface resistance and comprises carbon nanotubes.

Carbon nanotubes will hereinafter be referred to as “CNTs”. CNTs are microscopically small tubular structures (molecular nanotubes) composed of carbon. The diameter of the tubes is usually in the range 1-200 nm. Depending on the detail of the structure, the electrical conductivity within the tubes is metallic or semiconductive. Apart from the electrical properties, the mechanical properties of carbon nanotubes are also excellent: CNTs have a density of 1.3-2 g/cm³ and a tensile strength of 45 GPa. For the electronics industry, the current carrying capacity and the thermal conductivity are of particular interest: the former is, as an estimate, 1000 times higher than in the case of copper wires, while the latter is, at 6000 W/(m*K) at room temperature, nearly twice as high as that of diamond (3320 W/(m*K)).

CNTs can be added to materials in order to improve the electrical and/or mechanical and/or thermal properties of the materials. Such composites comprising CNTs are known from the prior art.

WO-A 2003/079375 claims polymeric material which displays mechanically and electrically improved properties as a result of the addition of CNTs.

WO-A 2005/015574 discloses compositions containing organic polymer and CNTs which form rope-like agglomerates and contain at least 0.1% of impurities. The compositions display a reduced electrical resistance and also a minimum level of notched impact toughness.

It is known that nanoparticles form agglomerates which have to be broken up in order to obtain a very homogeneous distribution of the nanoparticles in the composite (A. Kwade, C. Schilde, Dispersing Nanosized Particles, CHEManager Europe 4 (2007), page 7; WO-A 94/23433). CNT agglomerates can be broken up by introduction of shear forces into the dispersion (WO-A 94/23433).

It is known that glass fibres which are added to plastics to improve the mechanical and thermal properties experience shortening as a result of stress as occurs, for example, on introduction of shear forces (F. Johannaber, W. Michaeli, Handbuch Spritzgieβen, 2nd edition, Carl Hanser Verlag 2004, chapter 5.8.6).

Preference is given to using CNTs having a high ratio of length l to diameter d (aspect ratio) because of their better electrical properties (Zhu et al., Growth and electrical characterization of high-aspect-ratio carbon nanotube arrays, Carbon, Volume 44, Issue 2, February 2006, pages 253-258). It is feared that shortening can occur as a result of high stress on the CNTs, as in the case of glass fibres. In the publication WO-A 05/23937, the energy input in the extruder is therefore explicitly limited so as not to shorten the CNTs (see, for example, page 6, lines 8-34 or page 11, lines 7-13).

According to prevailing opinion in the art, not only sufficient shear but also penetration of the medium into the interior of the CNT agglomerates (infiltration) is considered to be necessary for dispersing the CNT agglomerates (G. Kasaliwal, A. Göldel, P. Pötschke, Influence of processing conditions in small scale melt mixing and compressing molding on the resistivity of polycarbonate-MWNT composites, Proceedings of the Polymer Processing Society, 24th Annual Meeting, PPS24, Jun. 15-19, 2008 Salerno, Italy; WO-A 94/23433). Owing to the infiltration process which is considered to be necessary, it is expressly stated in the abovementioned publications by Kasaliwal et. al., that a high viscosity is disadvantageous for reducing the CNT agglomerate size. In the publication WO-A 94/23433 it is recommended that the temperature in the extruder be increased at the commencement of dispersion in order to improve the wetting behaviour and the penetration of the medium into the interior of the CNT agglomerates. For the same reasons, polymers having a low viscosity or processing viscosity are recommended as preferred for masterbatches containing CNTs (see, for example, WO-A 94/23433 page 13, lines 11 to 24).

In the light of the prior art, it is an object of the invention to provide a process for producing composites which comprise carbon nanotubes (CNTs) and have a reduced resistance, in which CNT agglomerates are dispersed in a fluid material and are homogeneously distributed in the material in such a way that the CNTs form a three-dimensional network in the material. In particular, the number of CNT agglomerates having an equivalent-sphere diameter of greater than 20 μm per square millimetre in the composite should be less than 20 multiplied by the CNT concentration in percent (for a CNT content of 5%, thus less than 100). The number of CNT agglomerates having an equivalent-sphere diameter of greater than 20 μm per square millimetre in the composite should particularly preferably be less than 2 multiplied by the concentration in percent.

Furthermore, the process should be able to be modified (employed) without problems for throughputs on an industrial scale, i.e. be able to be scaled up to large throughputs on the tonne scale. Furthermore, the process should cause no appreciable shortening of the CNTs.

It has, surprisingly, been found that the object can be achieved by subjecting the CNT agglomerates to a minimum stress which leads to breaking up of the CNT agglomerates without the CNTs being appreciably shortened during dispersion in a fluid medium, with the minimum stress being dependent on the required size distribution of the CNTs in the composite but independent of the fluid material chosen.

The present invention accordingly provides a process for producing a composite which has a reduced electrical resistance and comprises carbon nanotubes (CNTs) having a predeterminable size distribution, characterized in that a mixture comprising at least CNTs and a fluid material is subjected in a dispersing machine to a minimum stress determined empirically as a function of the predetermined size distribution, with the stress preferably being the maximum shear stress occurring in the dispersing machine.

For the purposes of the invention “carbon nanotubes” are essentially cylindrical compounds which consist mainly of carbon. The essentially cylindrical compounds can have a single wall (single wall carbon nanotubes, SWNT) or multiple walls (multiwall carbon nanotubes, MWNTs). They have a diameter d in the range from 1 to 200 nm and a length/which is a multiple of the diameter. The l/d ratio (aspect ratio) is preferably at least 10, particularly preferably at least 30. For the present purposes, the term “carbon nanotubes” refers to compounds which consist entirely or mainly of carbon. Accordingly, carbon nanotubes containing “foreign atoms” (e.g. H, O, N) are also encompassed by the term carbon nanotubes. Such carbon nanotubes according to the invention are referred to here as CNTs for short.

The CNTs used preferably have an average diameter of 3 to 100 nm, preferably from 5 to 80 nm, particularly preferably from 6 to 60 nm.

Customary processes for producing CNTs are, for example electric arc processes (arc discharge), laser ablation, chemical deposition from the vapour phase (CVD process) and catalytic chemical deposition from the vapour phase (CCVD process).

Preference is given to using CNTs which can be obtained from catalytic processes since these generally have a lower proportion of, for example, graphite- or soot-like impurities. A process which is particularly preferably used for producing CNTs is known from WO-A 2006/050903.

The CNTs are generally obtained in the form of agglomerates having an equivalent-sphere diameter in the range from 0.05 to 2 mm.

The CNTs incorporated according to the invention into the composite reduce the electrical resistance of the material, i.e. the conductivity is increased. For the purposes of the present invention, a “reduced electrical resistance” means a surface resistance of less than 10⁷ ohm/sq (Ω/sq) (for measurement of the surface resistance, see Figure XX).

For the purposes of the present invention, a “fluid” material is a viscous material or a viscoelastic material or a viscoplastic material or a plastic material or material having a yield point. In particular, the term “fluid” material refers to suspensions, pastes, liquids and melts. Accordingly, materials which are present in a “fluid” state, can be converted to a “fluid” state or have a “fluid” precursor are used in the production according to the invention of CNT composites.

Materials which can be used are, for example, suspensions, pastes, glass, ceramic compositions, metals in the form of a melt, plastics, polymer melts, polymer solutions and rubber compositions. Preference is given to using plastics and polymer solutions, particularly preferably thermoplastic polymers. As thermoplastic polymer, preference is given to using at least one polymer selected from the group consisting of polycarbonate, polyamide, polyester, in particular polybutylene terephthalate and polyethylene terephthalate, polyether, thermoplastic polyurethane, polyacetal, fluoropolymers, in particular polyvinylidene fluoride, polyether sulphones, polyolefins, in particular polyethylene and polypropylene, polyimide, polyacrylate, in particular poly(methyl) methacrylate, polyphenylene oxide, polyphenylene sulphide, polyether ketone, polyaryl ether ketone, styrene polymers, in particular polystyrene, styrene copolymers, in particular styrene-acrylonitrile copolymer, acrylonitrile-butadiene-styrene block copolymers and polyvinyl chloride. Preference is likewise given to using blends of the plastics listed, which a person skilled in the art will understand to be a combination of two or more plastics.

Further preferred starting materials are rubbers. As rubber, preference is given to using at least one rubber selected from the group consisting of styrene-butadiene rubber, natural rubber, butadiene-rubber, isoprene rubber, ethylene-propylene-diene rubber, ethylene-propylene rubber, butadiene-acrylonitrile rubber, hydrogenated nitrile rubber, butyl rubber, halobutyl rubber, chloroprene rubber, ethylene-vinyl acetate rubber, polyurethane rubber, thermoplastic polyurethane, guttapercha, arylate rubber, fluororubber, silicone rubber, sulphide rubber, chlorosulphonyl-polyethylene rubber. A combination of two or more of the rubbers listed, or a combination of one or more rubber with one or more plastics is naturally also possible.

To produce a composite having a reduced resistance according to the invention, CNTs in the form of agglomerates are mixed with at least one further material. The material is, if appropriate, heated in order to convert the material into a “fluid” state before, during or after the addition of CNTs. It is likewise conceivable to achieve the “fluid” state by introduction of mechanical energy.

According to the invention, the CNT agglomerates are broken up by applying a minimum stress to the mixture comprising at least CNTs and a fluid material. The minimum stress is achieved by introduction of energy into the mixture. This is effected using a dispersing machine whose task is to disperse CNTs in a material.

As dispersing machines, it is possible to use, for example, the following machines: single-screw extruders, corotating or contrarotating twin-screw or multi-screw extruders, in particular corotating twin-screw extruders such as the ZSK 26 from Coperion Werner & Pfleiderer, planetary-gear extruders, internal mixers, ring extruders, kneaders, calenders, Ko-Kneaders or a combination of at least two of the machines mentioned.

Dispersing machines introduce energy into the mixture, comprising at least CNTs and a fluid material, leading to the CNT agglomerates being broken up and the CNTs being distributed in the fluid material. In many dispersing machines, there are preferred shear stresses which lead to this desired effect. However, it will be clear to a person skilled in the art that stressing of the mixture can be effected not only by shear stress but also by compressive or stretching stress or by any desired combination of stresses. Accordingly, shear stress is to be interpreted generally as a stress which has an effect analogous to a shear stress, i.e. leads to breaking up of the CNT agglomerates and dispersion of the CNTs in the material (see also equations 1 and 2). In a preferred embodiment, the minimum stress is expressed by the maximum shear stress occurring in the dispersing machine used.

The minimum stress is preferably determined empirically. Here, microscopically or macroscopically measurable characteristic target parameters can be defined. For example, it is possible to define a minimum conductivity at a given CNT concentration. As a person skilled in the art will know, the conductivity of a CNT composite increases when the CNT agglomerates decreases and the amount of deagglomerated CNTs dispersed in the material increases. Accordingly, it is useful to set a minimum conductivity established at a minimum stress. The minimum stress required to achieve the required minimum conductivity can be determined empirically. The conductivity or its reciprocal the resistance (preferably the surface resistance) is considered to be a macroscopically measurable parameter.

It is likewise possible to follow the breaking up of the CNT agglomerates by measurement and to define a characteristic size distribution of the CNT agglomerates as target parameter. The measurement of the size distribution of the CNT agglomerates can be carried out, for example, by means of a microscope, which is why the characteristic parameter is considered to be a microscopically measurable parameter.

A possible characteristic target parameter would be, for example, a number of CNT agglomerates having an equivalent-sphere diameter of greater than 20 μm per square millimetre in the composite of less than 20 multiplied by the CNT concentration in percent (for a CNT concentrate of 5% thus less than 100). A particularly preferred target parameter is a number of CNT agglomerates having an equivalent-sphere diameter of greater than 20 μm per square millimetre in the composite of less than 2 multiplied by the concentration in percent. It has been found empirically that such a size distribution of the CNTs in the composite leads to a reduced electrical resistance. CLSM (confocal laser scanning microscopy) images are very well suited to determining the number of CNT agglomerates above or below a particular size.

Kasaliwal et al. (G. Kasaliwal, A. Göldel, P. Pötschke, Influence of processing conditions in small scale melt mixing and compressing molding on the resistivity of polycarbonate-MWNT composites, Proceedings of the Polymer Processing Society, 24th Annual Meeting, PPS24, Jun. 15-19, 2008 Salerno, Italy) define a dispersion quality DG (“macro dispersion index”). The dispersion quality DQ is determined with the aid of micrographs of the CNT composite. It is calculated as the ratio of the area A, which is made up by agglomerates having an area greater than a particular threshold value (Kasaliwal et al. assume 1 μm² as threshold value), to the total area A₀ of the evaluated micrograph of the CNT composite according to the following formula:

$$D Q = ( 1 - f \frac{A / {A}_{0}}{v} ) \cdot 100 \% . \qquad ( Eq . 12 )$$

Here, f is a factor which is correlated with the actual volume of the filler; in the case of CNT, Kasaliwal et al. indicate f=0.25. The value v indicates the proportion by volume of the CNTs in percent. This can be calculated easily from the mass fraction of the CNTs; according to Kasaliwal et al. the density of CNTs is about 1.75 g/cm³. A value of the dispersion quality of 100% means that no agglomerates which exceed the chosen limit value are present in the compound. This indicates the state of very good dispersion. Kasaliwal et al. restrict DQ to positive values and set the value of the dispersion quality to zero when the proportion by area of large CNT agglomerates becomes so large that the DQ according to the calculation formula becomes negative. Small values of DQ therefore describe a poor degree of dispersion. The dispersion quality DQ can also be used as a characteristic, microscopically measurable parameter and a corresponding target parameter can be defined.

It has been found, surprisingly, that a minimum stress, e.g. in the form of a minimum shear stress, is necessary to achieve a maximum conductivity at a given CNT content. Increasing the stress (shear stress) to a value above the minimum stress (minimum shear stress) does not lead to an increased conductivity. It has surprisingly been found that the stress within the mixture comprising CNTs and fluid material is the critical parameter for achieving a maximum conductivity. Furthermore, it was surprising that the relationship between minimum stress and maximum conductivity which was found is independent of the material used.

The CNT agglomerates are broken up by introduction of energy into the dispersing machine. According to the invention, the mixture of CNTs and at least one further material is subjected to a minimum stress. As a person skilled in the art will know and as can be derived from textbooks on flow and continuum mechanics, the stress state in a fluid can be described by a stress tensor which has the form

$$\underline{T} = ( \begin{matrix}{τ}_{xx} & {τ}_{xy} & {τ}_{xz} \\ {τ}_{yx} & {τ}_{yy} & {τ}_{yz} \\ {τ}_{zx} & {τ}_{yz} & {τ}_{zz}\end{matrix} ) . \qquad ( Eq . 1 )$$

This tensor is symmetrical, i.e. τ_{xy}=τ_{yx} and correspondingly for all other components off the main diagonals. The stress used according to the invention for breaking up the CNT agglomerates can be expressed by the representative stress τ according to Eq. 2, which describes any stress state:

$$τ = \sqrt{\frac{tr ( {\underline{T}}^{2} )}{2}} \qquad ( Eq . 2 )$$

Here, tr is the trace operator, i.e. the sum of the elements of the diagonals of the tensor. The square of the tensor T² is obtained according to the generally known rules of matrix multiplication. A person skilled in the art will know, e.g. from G. Böhme, Strömungsmechanik nicht-newtonscher Fluide, Stuttgart Teubner, 1981, 1st edition, ISBN 3-519-02354-7, that the stress tensor T in the case of Newtonian fluids depends linearly on the deformation rate tensor

$$\begin{matrix}\underline{D} = \frac{1}{2} ( grad \vec{v} + {( grad \vec{v} )}^{T} ) \text{:} & ( Eq . 3 ) \\ \underline{T} = 2 η \underline{D} & ( Eq . 4 )\end{matrix}$$

In the case of non-Newton media, the physical law which relates the stress tensor to the deformations is more complicated and can include both a dependence of the viscosity on the deformation rate tensor and a dependence on deformations in the past history of the fluid (G. Böhme, Strömungsmechanik nicht-newtonscher Fluide, Stuttgart Teubner, 1981, 1st edition, ISBN 3-519-02354-7).

The rheological properties of various materials and the various methods of measuring the viscosity may be found by a person skilled in the art in, for example, Gleiβle (M. Pahl, W. Gleiβle, H.-M. Laun, Praktische Rheologie der Kunststoffe and Elastomere, 1st edition, VDI-Verlag 1991). The viscosity can, for example, be determined by means of a capillary rheometer.

As a person skilled in the art will know, the Cox-Merz rule, which relates the viscosity measured in oscillatory rheometers to the shear viscosities measured in capillary or cone-and-plate rheometers, strictly speaking applies only to unfilled polymers. Nevertheless, viscosities measured under oscillatory conditions can serve as guide values for the shear viscosities of the mixtures comprising at least CNTs and a fluid material.

A person skilled in the art can readily estimate a maximum shear stress for some dispersing machines on the basis of mechanical parameters. In the case of plug flow in a tube having a length L and a radius R and a pressure drop Δp, the maximum shear stress at the wall is

$$τ = \frac{Δ pR}{L 2} \qquad ( Eq . 5 )$$

In the case of a slit having a height H and a length L through which flow occurs, the maximum shear stress is

$$τ = \frac{Δ p H}{L 2} \qquad ( Eq . 6 )$$

In the case of an orifice having a length L in the region of the laminar intake, the shear stress at the wall is

$$τ = \frac{1.328}{\sqrt{Re}} {p}_{dyn} \qquad ( Eq . 7 )$$

where Re is the Reynolds number and p_{dyn} is the dynamic pressure. The dynamic pressure is given by:

$${p}_{dyn} = \frac{1}{2} ρ {u}^{2} \qquad ( Eq . 8 )$$

where ρ is the density of the fluid and u is the velocity. The Reynolds number is given by:

$$Re = \frac{uL ρ}{η} \qquad ( Eq . 9 )$$

In the case of a wall of a gap moved by the wall velocity u (the other wall is fixed) having a height h, the maximum shear stress which occurs is given by

$$τ = \frac{u}{h} η \qquad ( Eq . 10 )$$

The viscosity η to be used in the above equations is the actual viscosity of the mixture comprising at least CNTs and a fluid material occurring during dispersion at the processing temperature and the actual shear rate in the dispersing machine.

A person skilled in the art will know that not all elements of the material can be subjected to the maximum shear stress which occurs. The stress which elements of the material experience in a dispersing machine has a distribution function. In the case of a Newtonian fluid, 50% of all particles of the material in a shear gap experience at least half the maximum stress. In the case of a corotating twin-screw extruder (for example ZSK from Coperion Werner & Pfleiderer), Kirchhoff (K. Kohlgrüber, Der gleichläufige Doppelschnecken extruder, Carl Hanser Verlag, 1st edition, Munich 2007, chapter 9.3) shows, for realistic parameters, that even at an L/D ratio of 10 (L=length of the extruder in the axial direction, D=barrel diameter) each fluid element flows an average of 3.5 times over the shear-intensive intermesh gap. In the case of real extruders having an L/D ratio significantly above 10, statistically significantly more than 50% of the fluid particles, i.e. the major part of the particles of the material, will experience at least half the maximum stress.

As a result of stressing being repeated two or more times (for example by stressing the CNT composite successively a number of times on the same machine), the proportion of CNT composite which has experienced more than a particular shear stress increases with each pass. This has been able to be confirmed experimentally for CNT agglomerates (see Example 2).

The minimum stress in the dispersing machine is preferably expressed by the maximum shear stress since this can be calculated easily, as shown above, and can easily be varied in a dispersing machine. It would be clear to a person skilled in the art that the maximum shear stress occurring in a dispersing machine is not absolutely necessary for breaking up the agglomerate. The shear stress actually required for breaking up a CNT agglomerate will be somewhat smaller than the maximum shear stress occurring in the dispersing machine; however, it cannot be determined/reported so easily. For this reason, the minimum stress is preferably expressed by the maximum shear stress occurring in the dispersing machine.

In a preferred embodiment of the process of the invention, CNT-containing composites which have a number of CNT agglomerates having an equivalent-sphere diameter greater than 20 μm per square millimetre of surface area of less than 20 multiplied by the CNT concentration, i.e. in the case of a CNT content of 5% the number of CNT agglomerates having an equivalent-sphere diameter of greater than 20 μm should thus be less than 100, are produced. The number of CNT agglomerates having an equivalent-sphere diameter of greater than 20 μm per square millimetre of surface area in the composite should particularly preferably be less than 2 multiplied by the concentration in percent.

The process of the invention is characterized in that a mixture comprising at least CNTs and a fluid material is subjected to a minimum stress of 75 000 Pa, with the stress preferably being the maximum shear stress occurring in the dispersing machine. The minimum stress is preferably greater than 90 000 Pa, particularly preferably greater than 100 000 Pa. An upper limit is imposed on the stress since otherwise irreversible damage to the CNT-polymer composite has to be expected. An upper stress limit of 2 000 000 Pa appears to be appropriate.

In the case of apparatuses for which the maximum shear stress which occurs cannot readily be calculated (for example in the case of dispersion in a die in which the flow is turbulent), the approach of Equation 11 is used, i.e. instead of the maximum shear stress which occurs, the average shear stress required for achieving the desired parameters is calculated.

In general: when a power P is dissipated in an apparatus having a volume V, the average shear stress is:

$$τ = \sqrt{\frac{P η}{V}} \qquad ( Eq . 11 )$$

In a preferred process, the specific mechanical energy input into the dispersing machine is set to a value in the range from 0.1 kWh/kg to 1 kWh/kg, preferably from 0.2 kWh/kg to 0.6 kWh/kg and the minimum residence time is set to a value in the range from 6 s to 90 s, preferably from 8 s to 30 s.

A person skilled in the art will know that, for example, in the incorporation of carbon blacks into materials, a high shear stress for a short residence time has the same effect as a low shear stress for a long residence time. In the case of CNT agglomerates, the shear stress required for dispersing the CNTs is significantly higher than in the case of conventional fillers (for example, carbon blacks), which is why CNTs are not readily dispersed successfully in low viscosity polymer melts. Dispersion of CNTs can therefore not be effected economically without a sufficiently high shear stress. In a preferred embodiment of the process of the invention, the minimum residence time of the mixture comprising at least CNTs and a fluid material in the dispersing machine is in the range from 6 s to 90 s, preferably from 8 s to 30 s. Higher residence times are generally no longer economical. Accordingly, a high stress is necessary to ensure that the CNT agglomerates are effectively broken up. In a preferred embodiment, the process of the invention is characterized in that the minimum stress is achieved by means of an appropriately high shear rate and/or an appropriately high viscosity.

The minimum stress in the form of the maximum shear stress occurring in the dispersing machine can be expressed as the product of shear rate (the maximum shear rate occurring in the dispersing machine) of the mixture (comprising at least CNTs and a fluid material) and viscosity (actual viscosity occurring in the mixture during dispersion at the processing temperature and actual shear rate in the dispersing machine). In a preferred embodiment of the process of the invention, in which the maximum shear rate which occurs is predetermined by the apparatus parameters of the dispersing machine, the viscosity of the mixture is selected so that the product of the viscosity and shear rate is greater than or equal to the minimum stress, which is preferably greater than or equal to 75 000 Pa, particularly preferably greater than 90 000 Pa, most preferably greater than 100 000 Pa. In a further preferred embodiment of the process of the invention, in which the viscosity of the mixture is laid down, the shear rate of the dispersing machine is selected so that the product of the maximum shear rate occurring in the dispersing machine and the viscosity is greater than or equal to the minimum stress, which is preferably greater than or equal to 75 000 Pa, particularly preferably greater than 90 000 Pa, most preferably greater than 100 000 Pa.

According to the prior art, the introduction of high shear forces to break up CNT agglomerates is known. However, according to the prior art a low viscosity is advised in order to ensure good wetting of the agglomerates and penetration of fluids into the agglomerates. It has surprisingly been found that a high viscosity is advantageous in breaking up the agglomerates.

Furthermore, it would have been expected that with increasing energy input the CNTs would be separated better but the length of the CNTs would steadily decrease. Since, according to the generally accepted theory, the electrical conductivity decreases with decreasing length/diameter ratio (aspect ratio) at a constant CNT content and degree of dispersion, it should firstly increase with increasing energy input because of the better separation of the CNTs but then drop again because of the decreasing l/d ratio of the CNTs. It has surprisingly been found that even at a high energy input in industrial, continuous dispersing machines, the electrical conductivity does not drop again. This has been found for customary residence times in dispersing machines (for example extruders) of 6-90 s. Kasaliwal et al. (G. Kasaliwal, A. Goldel, P. Nitschke, Influence of processing conditions in small scale melt mixing and compressing molding on the resistivity of polycarbonate-MWNT composites, Proceedings of the Polymer Processing Society, 24th Annual Meeting, PPS24, Jun. 15-19, 2008 Salerno, Italy) have reported a partial decrease in the conductivity at high rotation rates in a microcompounder, even though the CNT agglomerates are dispersed better at high rotation rates and the conductivity should therefore be better. Here, a shortening of the CNTs could occur since Kasaliwal et al. selected a long residence time of five minutes in the microcompounder. The residence time in continuously operated industrial dispersing machines (for example twin-screw extruders) is considerably shorter. For example, the average residence time in a corotating twin-screw extruder ZSK 26 Mc from Coperion Werner & Pfleiderer having an L/D ratio of 36 at a throughput of 20 kg/h is about 30 seconds. At a constant degree of fill, the extruder would have to be a factor 5 longer (L/D=180), in order to arrive at least half the residence time of 5 minutes. Conventional industrial compounding extruders have an L/D ratio of from 20 to 40.

A high viscosity of the dispersion can be achieved, for example, by choice of the material. If the material is, for example, a polymer, a higher viscosity can be achieved by choosing a type having a higher content of relatively long-chain molecules.

It is likewise conceivable to increase the viscosity of the dispersion by adding further materials, e.g. by adding fillers such as (nanosize) pyrogenic silica, carbon black, graphite, lime, talc, (glass) fibres, mica, kaolin, CaCO₃, glass flakes, dyes and pigments (e.g. titanium dioxide or iron oxide) or other materials. A high viscosity can also be influenced by the amount of fillers (CNT or/and others) with the viscosity generally increasing with increasing filler content.

Since the viscosity generally decreases greatly with increasing temperature (for example, viscosity of polymer melts), the viscosity is increased by means of a low processing temperature in a preferred embodiment of the process of the invention. It will be clear to a person skilled in the art that in the case of thermoplastic polymers the highest viscosities occur in the homogenizing section of the dispersing machine. A preferred embodiment of the process of the invention comprises setting a low value of the temperature of the dispersing machine (for example a twin-screw extruder) particularly in the region of the homogenizing section. In general, the temperature of the thermoplastic polymers in dispersing machines is lowest at the beginning, so that the viscosities are higher there as a result of the low temperature.

A preferred embodiment of the process of the invention comprises dispersing the CNT agglomerates in a single pass through a dispersing machine, since this is particularly economical. The smaller the desired size of the CNT agglomerates remaining in the compound, the higher the stresses required. If the required stress (shear stress) and, associated therewith, a desired CNT agglomerate size cannot be achieved in the first pass through a dispersing machine (for example in the case of polymers having a low viscosity), the CNT compound which has been obtained in the first pass through the dispersing machine is, in a preferred embodiment, processed again (two or more times) in the dispersing machine. According to the invention, the viscosity of the CNT compound is increased on each pass as a result of the higher proportion of dispersed CNTs, which in turn increases the stress (shear stress) and thus improves the dispersion quality in the next pass.

In a further preferred embodiment of the process of the invention, a higher concentration of CNTs than is intended in the future composite is incorporated into the material in a first step and a further amount of material is added to the dispersion in order to “dilute” the CNT concentration in a second step. The second step can be carried out downstream on the same dispersing machine but can also be carried out as an extra process step on the same dispersing machine or another dispersing machine. The addition of the higher concentration of CNTs in the first step has the same effect as the addition of fillers: the viscosity of the dispersion increases. When the shear forces are then introduced into the dispersion to break up the CNT agglomerates, the shear stress is higher than if a smaller amount of CNTs had been incorporated into the dispersion. Accordingly, a minimum shear stress is achieved at a lower shear rate, or the shear stress is higher in the case of the more highly concentrated CNT dispersion. According to the invention, the CNT agglomerates are effectively broken up without appreciable shortening of the CNTs occurring. In a second step, the amount of an identical material and/or a different material which is necessary to arrive at the composite having the desired CNT concentration is then added. In addition, the material which is added in the second step can have a different viscosity. In a preferred embodiment of the process of the invention, a material having the same or lower viscosity is added in the second step since lower viscosities are advantageous for further processing of the CNT compound.

Apart from the viscosity, the shear rate can also be increased in order to achieve the required minimum stress. A possible way of increasing the shear stress in a dispersing machine (for example single-screw extruders, corotating or contrarotating twin-screw or multi-screw extruders, in particular corotating twin-screw extruders such as the ZSK 26 Mc from Coperion Werner & Pfleiderer, planetary-gear extruders, internal mixers, ring extruders, kneaders, calenders, Ko-Kneaders) is, for example, to use higher rotation speeds. As a further possible way of increasing the shear rate, the gap width in the machines can be made small. Calenders, for example, have particularly narrow gaps in which very high shear rates occur.

In a further preferred embodiment of the process of the invention, CNTs are fed together with a thermoplastic polymer in the solid state into the main feed zone of a single-screw extruder or a corotating or contrarotating twin-screw or multi-screw extruder (an example which may be mentioned here is a corotating twin-screw extruder ZSK 26 Mc from Coperion Werner & Pfleiderer) or a planetary-gear extruder, of an internal mixer, or a ring extruder, or a kneader or a calender or a Ko-Kneader. The CNTs are predispersed in the feed zone by solid-state friction to form a solid-state mixture. In a homogenizing section following the feed zone, the polymer is melted and then CNTs are dispersed further in this homogenizing section predominantly by means of hydrodynamic forces and are homogeneously distributed in the polymer melt in further zones.

In the case of low-viscosity to medium-viscosity media having a viscosity at zero shear rate at room temperature in the range from 0.1 mPas to 500 Pas or materials having a yield point of up to 500 Pa, the CNTs are, for example, processed according to the invention to produce a composite by means of one or a combination of more than one of the following apparatuses: jet disperser, high-pressure homogenizers, rotor-stator systems (gear ring dispersing machines, colloid mills, . . . ), stirrers, nozzle systems, ultrasound.

In the case of low-viscosity media (containing CNTs), a high stress can be brought about by, for example, ultrasound. The cavitation which occurs here generates pressure pulses of over 1000 bar, which break up the CNT agglomerates effectively. Low-viscosity media (containing CNTs) can, for example, also be passed under high pressure (for example 10 bar-1000 bar) through narrow gaps (e.g. 0.05-2 mm) or correspondingly small holes or corresponding small slits (fixed components or with moving components), as a result of which high stresses occur. It will be clear to a person skilled in the art that a shear stress can be calculated according to Eq. 7 or Eq. 10 for such flows, even when they are, for example, turbulent.

The process of the invention offers the advantage that CNT composites having homogeneously dispersed CNTs and a reduced electrical resistance, high thermal conductivity and very good mechanical properties can be produced in an economically efficient way on an industrial scale. The process of the invention can be operated either continuously or batchwise; it is preferably operated continuously.

The invention also provides a CNT composite obtained by the process of the invention.

The invention further provides for the use of the CNT composite obtained by the process of the invention as electrically conductive material, electrically shielding material or material which conducts away electrostatic charges.

The invention is illustrated below with the aid of examples and drawings, without being restricted thereto.

In the drawings,

FIG. 1 shows a process flow diagram of a plant for carrying out the process

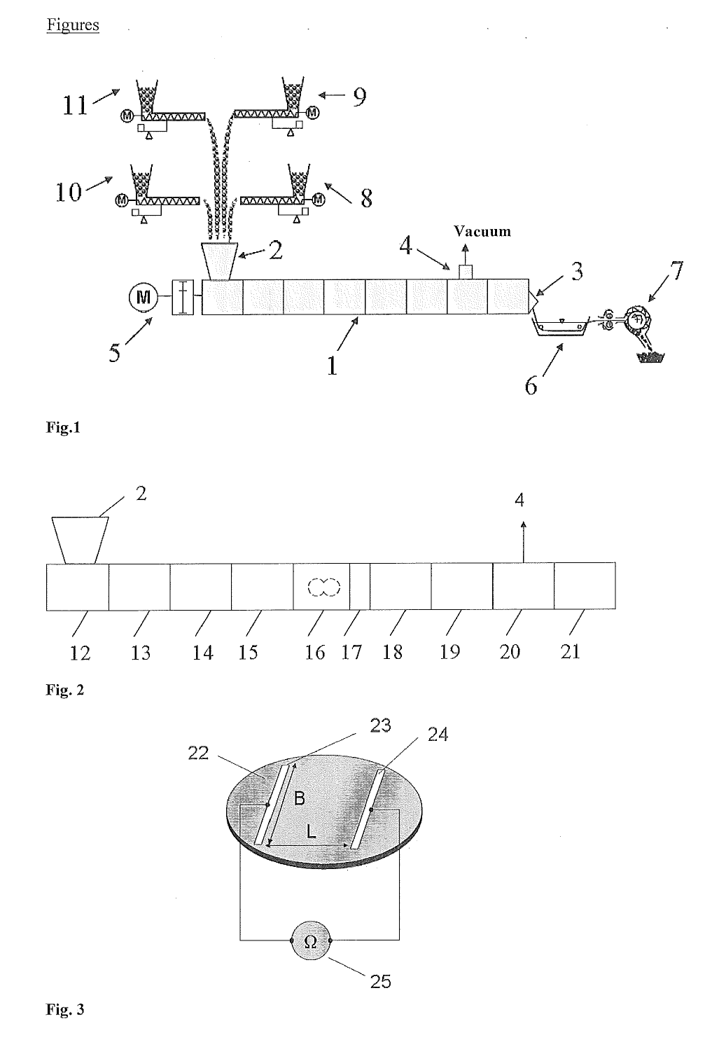

FIG. 2 shows a schematic longitudinal section of the twin-screw extruder used in the plant shown in FIG. 1

FIG. 3 shows a measuring arrangement for determining the electrical surface resistance of the CNT composites

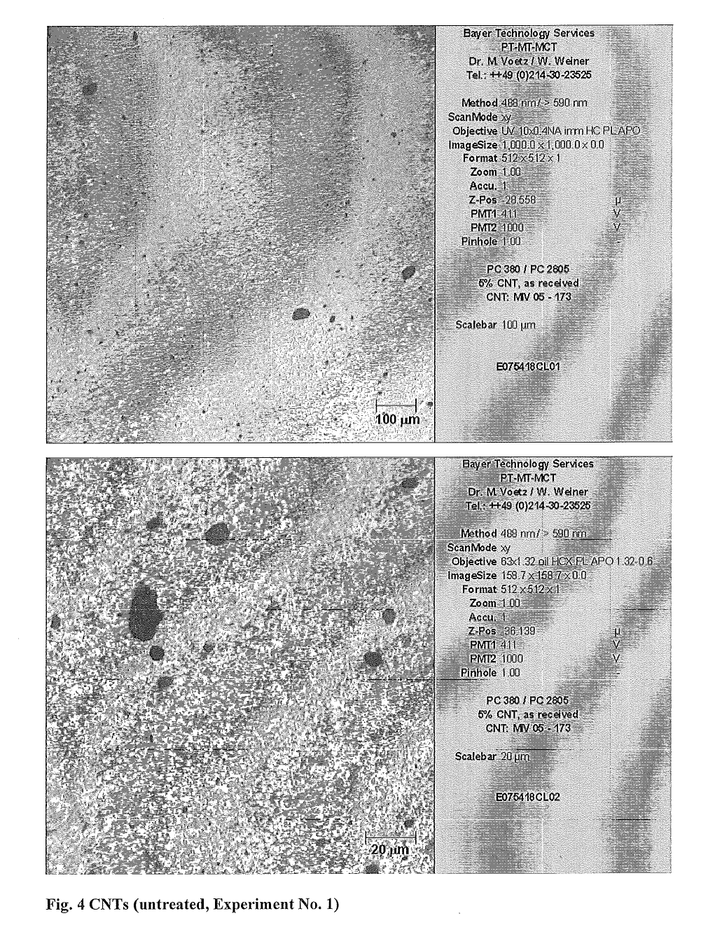

FIG. 4 shows a micrograph of CNTs from Example 1 (untreated, Experiment No. 1)

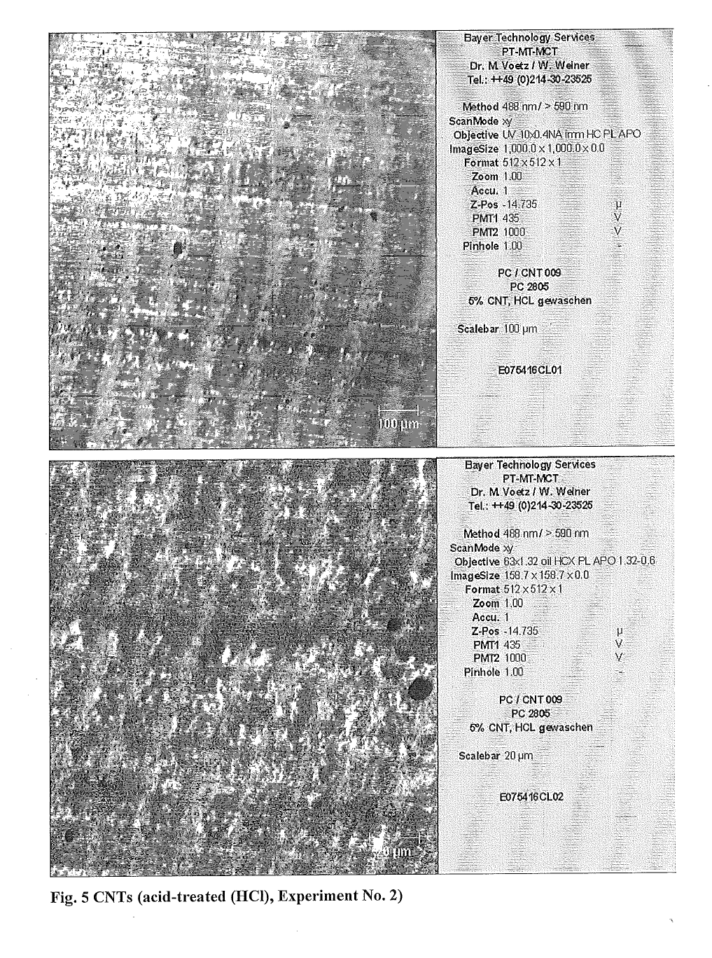

FIG. 5 shows a micrograph of CNTs from Example 1 (acid-treated (HCl), Experiment No. 2)

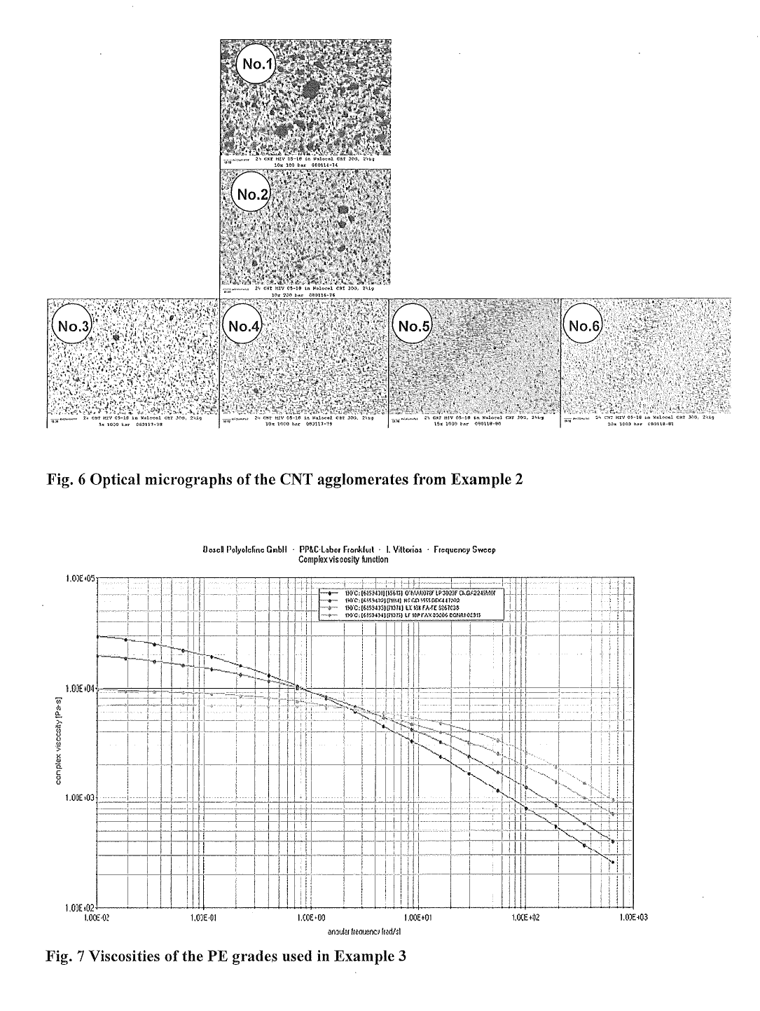

FIG. 6 shows optical micrographs of CNT agglomerates

FIG. 7 shows viscosities of the PE grades used in Example 3

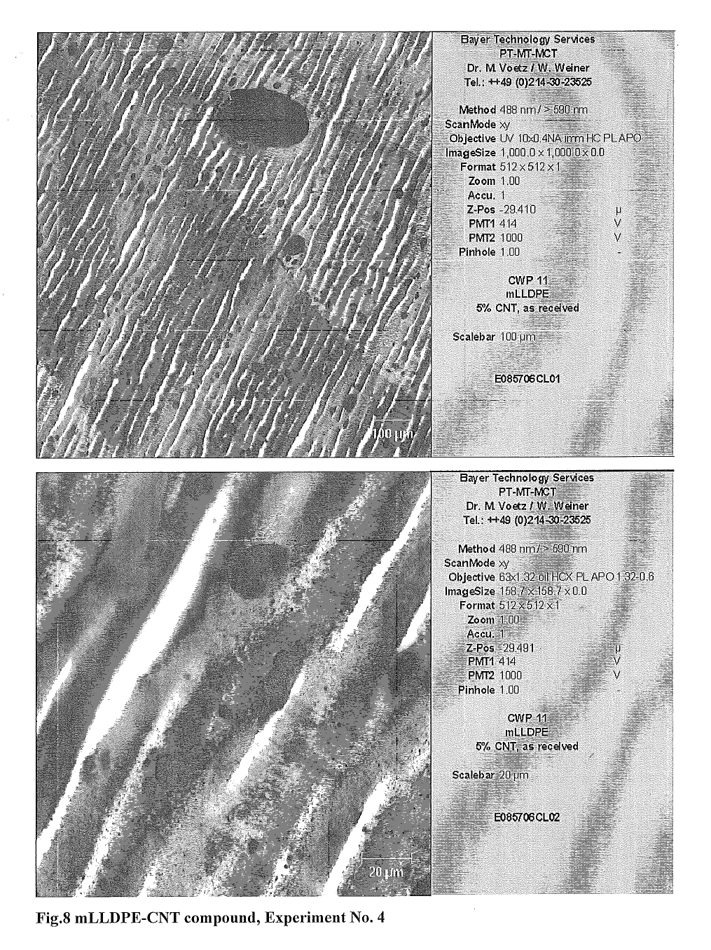

FIG. 8 shows a micrograph of an mLLDPE-CNT compound from Example 3, Experiment No. 4

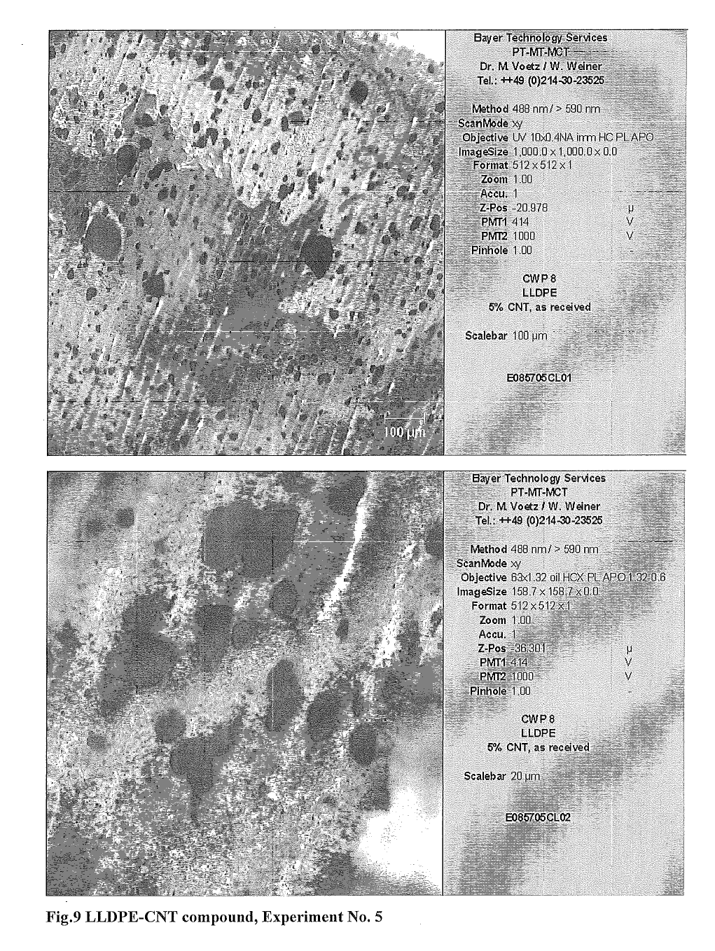

FIG. 9 shows a micrograph of an LLDPE-CNT compound from Example 3, Experiment No. 5

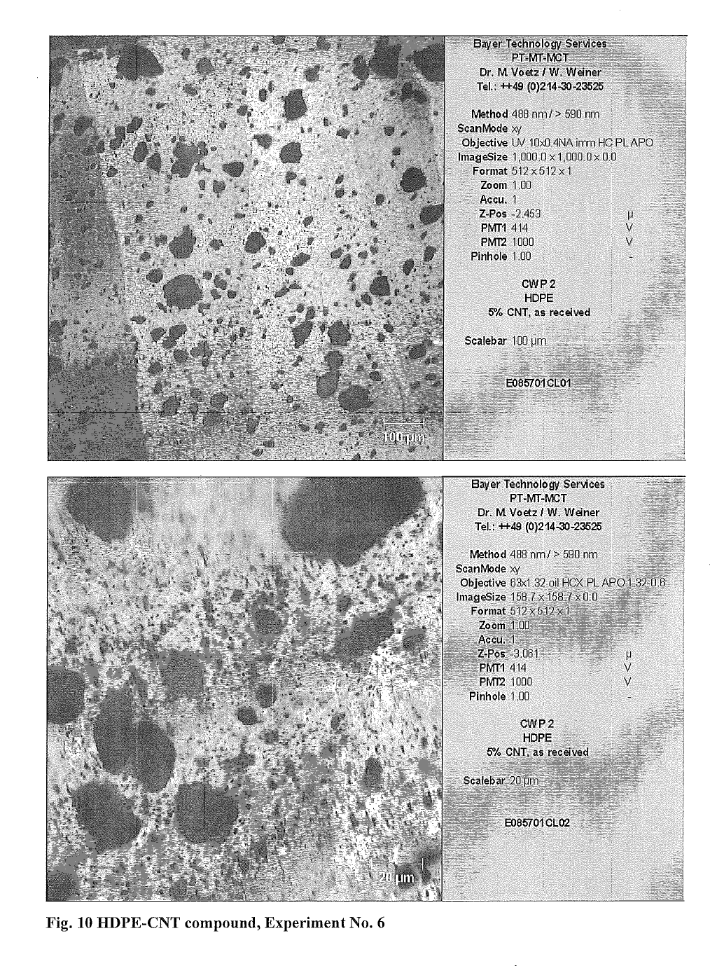

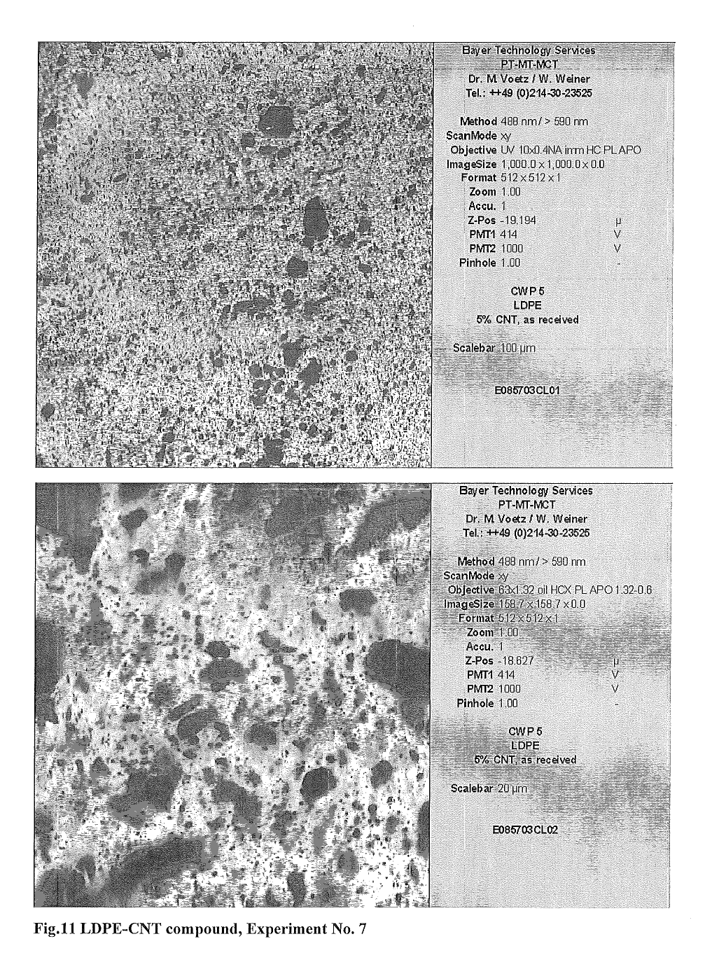

FIG. 10 shows a micrograph of an HDPE-CNT compound from Example 3, Experiment No. 6

FIG. 11 shows a micrograph of an LDPE-CNT compound from Example 3, Experiment No. 7

### EXAMPLES

The plant shown in FIG. 1 consists essentially of a twin-screw extruder 1 having a feed hopper 2, a product discharge die 3 and a vent 4. The two corotating screws (not shown) of the extruder 1 are driven by the motor 5. The constituents of the CNT composite (e.g. polymer 1, additives (e.g. antioxidants, UV stabilizers, mould release agents), CNTs, if appropriate polymer 2) are conveyed by means of feed screws 8-11 into the feed hopper 2 of the extruder 1. The strands of melts exiting from the die plate 3 are cooled and solidified in a water bath 6 and subsequently chopped by means of a pelletizer 7.

The twin-screw extruder 1 (see FIG. 2) has, inter alfa a barrel made up of ten parts and in which two corotating, intermeshing screws (not shown) are arranged. The components to be compounded including the CNT agglomerates are fed into the extruder 1 via the feed hopper 2 located on the barrel section 12.

In the region of the barrel sections 12 to 13 there is a feed zone which preferably comprises flights having a pitch of from twice the screw diameter (2 DM for short) to 0.9 DM. The flights convey the CNT agglomerates together with the other constituents of the CNT composite to the homogenizing section 14, 15 and intensively mix and predisperse the CNT agglomerates by means of frictional forces between the solid polymer pellets and the CNT powder which is likewise in the solid state.

In the region of the barrel sections 14 to 15, there is the homogenizing section, which preferably comprises kneading blocks; as an alternative, depending on the polymer, it is possible to use a combination of kneading blocks and gear mixing elements. In the homogenizing section 14, 15 the polymeric constituents are melted and the predispersed CNT and additives are further dispersed and intensively mixed with the other components of the composite. The temperature to which the extruder barrel is heated in the region of the homogenizing section 14, 15 is set to a value greater than the melting point of the polymer (in the case of partially crystalline thermoplastics) or the glass transition temperature (in the case of amorphous thermoplastics).

In the region of the barrel sections 16 to 19, an after-dispersing zone is provided between the transport elements of the screws downstream of the homogenizing section 14, 15. This after-dispersing zone has kneading and mixing elements which bring about frequent relocation of the melt streams and a broad residence time distribution. A particularly homogeneous distribution of the CNT in the polymer melt is achieved in this way. Very good results have been achieved using gear mixing elements. Furthermore, screw missing elements, eccentric discs, back-transporting elements, etc. can be used for mixing in the CNTs. As an alternative, it is also possible to arrange a plurality of after-dispersing zones in series in order to intensify fine dispersion. In each case, the combination of predispersion in the solid state, main dispersion during melting of the polymer/polymers and subsequent fine dispersion taking place in the liquid phase is important for achieving a very uniform CNT distribution in the polymer.

The removal of volatile substances is effected in a devolatilizing section in barrel section 20 via a vent 4 which is connected to a vacuum facility (not shown). The devolatilizing section comprises flights having a pitch of at least 1 DM.

The last barrel section 21 comprises a pressure buildup zone at the end of which the compounded and devolatilized product leaves the extruder. The pressure buildup zone 21 has flights having a pitch of from 0.5 DM to 1.5 DM.

The CNT composites obtained (in the form of pellets) can subsequently be processed further using all known methods of processing thermoplastics. In particular, mouldings can be produced by injection moulding.

The measurement of the electrical surface resistance was carried out as shown in FIG. 3. Two conductive silver strips 23, 24 are applied to the circular test specimen 22 produced by injection moulding and having a diameter of 80 mm and a thickness of 2 mm; the length B of these strips 23, 24 is equal to their spacing L, so that a square area sq is defined. The electrodes of a resistance measuring instrument 25 are subsequently pressed on to the conductive silver strips 23, 24 and the resistance is read off on the measuring instrument 25. A measurement voltage of 9 volt was used at resistances of up to 3×10⁷ ohm/sq and was 100 volt above 3×10⁷ ohm/sq.

### Example 1

The incorporation of multiwall carbon nanotubes (CNTs produced by catalytic gas phase deposition as described in WO 2006/050903 A2, for example obtainable as commercial product Baytubes® C 150P, manufacturer: Bayer MaterialScience AG) into polycarbonate (PC) (commercial product: Makrolon® 2805, manufacturer: Bayer MaterialScience AG) was carried out on a corotating twin-screw extruder model ZSK 26 Mc (Coperion Werner & Pfleiderer). In Experiment 1, both the polymer pellets and the CNTs were fed into the extruder via the main feed section or feed hopper 2. In Experiment 2 the CNTs were purified by means of an acid wash (HCl).

The process parameters are shown in Table 1 below. The screw configuration used had 23.6% of kneading elements.

The melt temperature was measured by means of a commercial temperature sensor directly in the strand of melts leaving the die plate 3.

The specific mechanical energy input was calculated by means of the following equation:

Specific mechanical energy input=2*Pi*rotational speed*torque of the screws/throughput

(Pi=ratio of circumference to diameter of a circle)

Number and Diameter of the Incompletely Dispersed Cnt Agglomerates Present in the Carbon nanotube/polymer composite are measured by means of an optical microscope on a 5 cm long strand of the CNT-polymer composite.

TABLE 1

| | | | Exper- | Exper- |
|---|---|---|---|---|
| | | | iment | iment |
| | | | No. 1 | No. 2 |
| | | | (PC380) | (CNT009) |
| CNT content | % by | | 5 | 5 |
| | weight | | | |
| Throughput | kg/h | | 24 | 24 |
| Rotational speed | 1/min | | 400 | 400 |
| Specific mechanical energy input | kWh/kg | | 0.289 | 0.296 |
| Pressure at the die head | MPa | | 1.3 | 1.6 |
| Barrel temperature in the | ° C. | | 280 | 280 |
| homogenizing section | | | | |
| Melt temperature | ° C. | | 298 | 341 |
| Number of particles in the diameter | 20-40 | μm | 3 | 4 |
| range (area evaluated = 1 mm × | | | | |
| 1 mm) | | | | |
| Number of particles in the diameter | >40 | μm | 0 | 0 |
| range (area evaluated = 1 mm × | | | | |
| 1 mm) | | | | |
| Number of particles in the diameter | 5-10 | μm | 10 | 5 |
| range (area evaluated =150 μm × | | | | |
| 150 μm) | | | | |
| Number of particles in the diameter | >10 | μm | 1 | 0 |
| range (area evaluated = 150 μm × | | | | |
| 150 μm) | | | | |

| | | | |
|---|---|---|---|
| Surface resistance measured on an | Ω/sq. | 5 250/ | 20 150/ |
| injection-moulded plate Ø80 mm | | 2 930 | 14 430 |
| (in the injection moulding | | | |
| direction/perpendicular to the | | | |
| injection moulding direction) | | | |
| Shear rate in the extruder (gap | 1/s | 6 807 | 6 807 |
| 0.08 mm, new elements) | | | |
| Viscosity of the pure polycarbonate | Pas | 119.6 | 74.5 |
| (real viscosity is higher) at a shear | | | |
| rate of 6807 1/s and melt temp. | | | |
| indicated above | | | |
| Maximum shear stress in the shear | Pa | 813 972 | 506 805 |
| gap (gap 0.08 mm, new elements) | | | |
| Shear rate in the extruder | 1/s | 544.5 | 544.5 |
| (real gap 1 mm) | | | |
| Viscosity of the pure polycarbonate | Pas | 421.8 | 154.6 |
| (real viscosity is higher) at a shear | | | |
| rate of 6807 1/s and melt temp. | | | |
| indicated above | | | |
| Maximum shear stress in the shear | Pa | 229 675 | 84 167 |
| gap (real gap 1 mm) | | | |

No significant difference in the CNT agglomerate size between the two Experiments 1 and 2 can be observed. Since the elements have already suffered considerable wear, the real gap is about 1 mm. The surface resistance decreases with increasing shear stress, which can be attributed to the resulting increased proportion of separate, individual CNTs.

### Example 2

200 g of carboxymethylcellulose (Walocel CRT 30G) and 200 g of MWNT (CNTs produced by catalytic gas phase deposition as described in WO 2006/050903 A2, for example obtainable as commercial product Baytubes® C 150P, manufacturer: Bayer MaterialScience AG) are stirred into 9600 g of water at room temperature. The mixture is dispersed once by means of a jet disperser at 60 bar. The general geometry of the jet disperser is described in EP 0101007 B1. The jet disperser used had a hole having a diameter of 1 mm. A diaphragm pump from Wagner (model: Finisch 106 B-EX, maximum pressure: 250 bar) was used for the experiments. After dispersing, a maximum particle size of about 80 μm was observed under an optical microscope.

Further dispersing was carried out at 100 bar using a piston pump from Böllhoff (model: 060.020.-DP, maximum pressure: 420 bar). A jet disperser having a hole having a diameter of 0.6 mm was used. The throughput was about 72 kg/h. After passing through the jet disperser, the suspension was collected and the dispersing step was repeated. Dispersing was carried out in a total of 10 passes at 100 bar. A maximum particle size of about 20 μm was then observed under an optical microscope (FIG. 6, No. 1).

Further dispersing was carried out at 200 bar, once again using the same piston pump from Böllhoff (model: 060.020.-DP, maximum pressure: 420 bar). Dispersing was carried out in 10 passes using a jet disperser having a hole having a diameter of 0.35 mm. The throughput was about 47 kg/h. A maximum particle size of about 10 μm was then observed under an optical microscope (FIG. 6, No. 2).

The dispersion was subsequently dispersed further at 200 bar using a jet disperser having a hole having a diameter of 0.35 mm. This dispersing was carried out with circulation. This means that the dispersion was not collected after passing through the jet disperser but fed directly to the pump. This dispersing was continued until the dispersion had a temperature of about 45° C. The time elapsed corresponded approximately to 5 passes. Another 15 passes at 200 bar were subsequently carried out. These were again “genuine” passes in which the dispersion was collected and then fed to the pump.

2 litres of the dispersion which had been treated in this way were placed in a reservoir and homogenized at 1000 bar. This dispersing was carried out using a pneumatically operated high-pressure piston pump from Maximator (model: GSF250-3LVES-494, maximum static pressure: 4500 bar, maximum dynamic pressure: 2500 bar) and an orifice plate having a hole diameter of 0.2 mm. The throughput was about 21 kg/h. After each pass, the dispersion was collected in a cooled vessel. After 5 passes, a maximum particle size of about 4 μm was observed under an optical microscope (FIG. 6, No. 3).

After a further 5 passes (total of 10 passes), a maximum particle size of about 3 μm was observed under an optical microscope (FIG. 6, No. 4).

After a further 5 passes (total of 15 passes), a maximum particle size of about 2 μm was observed under an optical microscope (FIG. 6, No. 5).

After a further 5 passes (total of 20 passes), a maximum particle size of about 1 μm was observed under an optical microscope (FIG. 6, No. 6).

A representative (average) shear stress for the turbulent outflow zone of a jet disperser can be calculated according to Eq. 10. This additionally requires the volume of the turbulent outflow zone, which can be estimated as follows: the outflow zone can be described as a truncated cone having a diameter of D at the nozzle and a diameter of 3D at the end and a length of 9D. At a nozzle diameter of 0.4 mm, a throughput of 20 kg/h, a pressure drop of 1000 bar (inlet and outlet pressure drops are disregarded here) and a viscosity of 1×10⁻¹ Pas (the true viscosity is significantly increased by the CNT agglomerates), the representative shear stress according to Eq. 10 is 1.76×10⁴ Pa. For the realistic assumption of a real viscosity of 1 Pas, a representative (average) shear stress of 5.57×10⁵ Pa is obtained.

### Example 3

The incorporation of multiwall carbon nanotubes (CNTs produced by catalytic gas phase deposition as described in WO 2006/050903 A2, for example obtainable as commercial product Baytubes® C 150P, manufacturer Bayer MaterialScience AG) into four different polyethylene grades (mLLDPE, LLDPE, HDPE, LDPE) (commercial products: LF18P FAX (mLLDPE), LX18 K FA-TE (LLDPE), HS GD 95555 (HDPE), LP 3020 F (LDPE), manufacturer: Basell) was carried out on a corotating twin-screw extruder model: ZSK 26 Mc (Coperion Werner & Pfleiderer). In all experiments, both the polymer pellets and the CNTs were fed into the extruder via the main feed section or feed hopper 2.

The process parameters are shown in Table 2 below.

The screw configuration used had 28.3% of kneading elements.

The melt temperature was measured by means of a commercial temperature sensor directly in the strand of melts leaving the die plate 3.

The specific mechanical energy input was calculated by means of the following equation:

Specific mechanical energy input=2*Pi*rotational speed*torque of the screws/throughput

(Pi=ratio of circumference to diameter of a circle)

Number and Diameter of the Incompletely Dispersed Cnt Agglomerates Present in the Carbon nanotube/polymer composite are measured by means of an optical microscope on a 5 cm long strand of the CNT-polymer composite.

TABLE 2

| | | | Experiment | Experiment | Experiment | Experiment |
|---|---|---|---|---|---|---|
| | | | No. 4 | No. 5 | No. 6 | No. 7 |
| | | | (CWP11) | (CWP8) | (CWP2) | (CWP5) |
| Polymer | | | mLLDPE | LLDPE | HDPE | LDPE |
| Machine | | | ZSK18 | ZSK18 | ZSK18 | ZSK18 |
| CNT content | % by | | 5 | 5 | 5 | 5 |
| | weight | | | | | |
| Throughput | kg/h | | 8 | 8 | 8 | 8 |
| Rotational speed | 1/min | | 900 | 900 | 900 | 900 |
| Specific mechanical energy input | kWh/kg | | 0.469 | 0.497 | 0.422 | 0.422 |
| Pressure at the die head | MPa | | 5.3 | 5 | 3 | 3.3 |
| Barrel temperature in the | ° C. | | 200 | 200 | 200 | 200 |
| homogenizing section | | | | | | |
| Melt temperature | ° C. | | 193 | 192 | 195 | 193 |
| Number of particles in the | 20-40 | μm | 64 | 112 | 208 | 112 |
| diameter range (area evaluated = | | | | | | |
| 1 mm × 1 mm) | | | | | | |
| Number of particles in the | >40 | μm | 4 | 7 | 26 | 23 |
| diameter range (area evaluated = | | | | | | |
| 1 mm × 1 mm) | | | | | | |
| Number of particles in the | 5-10 | μm | 7 | 9 | 10 | 11 |
| diameter range (area evaluated = | | | | | | |
| 150 μm × 150 μm) | | | | | | |
| Number of particles in the | >10 | μm | 3 | 14 | 6 | 12 |
| diameter range (area evaluated = | | | | | | |
| 150 μm × 150 μm) | | | | | | |

| | | | | | |
|---|---|---|---|---|---|
| Surface resistance | Ω/sq. | 1.89E2 | 4.77E3 | 1.0E11 | 1.0E11 |

In the prior art, the differing conductivity of various compounds of CNTs with PE grades is attributed to the differing degree of crystallinity (Effects of Crystallization on Dispersion of Carbon Nanofibers and Electrical Properties of Polymer Nanocomposites, S. C. Tjong, G. D. Liang, S. P. Bao, Polymer Engineering and Science 2008, pp 177-183, DOI 10.1002/pen). This explanation is purely phenomenological. In the experiments carried out, it was surprisingly able to be shown that there is a better explanation for the differing conductivity of various PE grade CNT compounds: Example 3 shows very different conductivities and different distributions of CNT agglomerates for various PE grades and identical compounding conditions. The higher the viscosity of the PE grade under process conditions (typical shear rates in an extruder are in the order of from 1000 to several 1000 reciprocal seconds), the higher the stress on the CNT composite and the better the dispersion of the CNT agglomerates. A better dispersing quality also results in an increase in conductivity. Example 3 shows explicitly that a particular stress is necessary for good conductivity to be achieved and the CNT agglomerates to go below a particular size. The higher the shear stress, the smaller the remaining CNT agglomerates. As the dispersion of the CNTs improves, a smaller proportion of CNTs is required to make the CNT-PE compounds conductive; the percolation threshold shifts to lower CNT contents. These experiments were carried out on a ZSK18. This machine size has a particularly high surface area to volume ratio, as a result of which the melt is strongly cooled. For this machine size, the melt temperature measured at the extruder outlet says nothing about the actual melt temperatures in the machine, so that a calculation of the shear stress occurring is therefore omitted.

Since for the first two examples the stress for dispersing the CNTs is in the same order of magnitude although completely different materials systems are present, the hypothesis that the highest shear stress occurring during processing is the critical parameter for the electrical conductivity of CNT composites and for dispersing the CNTs is justified. This conclusion is also supported by the third example.

1.-11. (canceled)

12. A process for producing a composite having a reduced electrical resistance which comprises
a. providing a mixture comprising a fluid material and carbon nanotubes (CNTs) having a predeterminable size distribution; and
b. subjecting the mixture to a minimum stress in a dispersing machine, wherein the minimum stress is determined empirically as a function of the predetermined size distribution;
to form a composite having a reduced electrical resistance.

13. The process according to claim 12, wherein the minimum stress is the maximum shear stress occurring in the dispersing machine.

14. The process according to claim 12, wherein the composite comprises a distribution of CNT agglomerates, and wherein the number of CNT agglomerates having an equivalent-sphere diameter of greater than 20 μm per square millimeter of surface area in the composite is less than 20 multiplied by the CNT concentration in percent.

15. The process according to claim 14, wherein the number of CNT agglomerates having an equivalent-sphere diameter of greater than 20 μm per square millimeter of surface area in the composite is less than 2 multiplied by the CNT concentration in percent.

16. The process according to claim 13, wherein the maximum shear stress occurring in the dispersing machine is at least 75,000 Pa.

17. The process according to claim 12, wherein the viscosity of the mixture at a maximum shear rate Y occurring in the dispersing machine is at least 75,000 Pa divided by Y.

18. The process according to claim 12, wherein the shear rate of the dispersing machine used is at least 75,000 Pa divided by Z, wherein Z is the viscosity of the mixture at the shear rate.

19. The process according to claim 12, wherein the mixture in the dispersing machine has a minimum residence time of from 6 to 90 s.

20. The process according to claim 19, wherein the mixture in the dispersing machine has a minimum residence time of from 8 to 30 s.

21. The process according to claim 12, wherein the dispersing machine has a specific mechanical energy input value in the range of from 0.1 to 1 kWh/kg.

22. The process according to claim 12, wherein the dispersing machine has a specific mechanical energy input value in the range of from 0.2 to 0.6 kWh/kg.

23. The process according to claim 12, wherein the mixture is stressed in the dispersing machine a plurality of times.

24. A process for producing a composite having a reduced electrical resistance which comprises
a) providing a first mixture comprising a fluid material and carbon nanotubes (CNTs) having a predeterminable size distribution;
b) subjecting the first mixture to a to a first stress of at least 75 000 Pa in a dispersing machine;
c) admixing the stressed first mixture with a material of equal or lower viscosity to form a second mixture; and
d) subjecting the second mixture to a second stress, wherein the second stress is less than the first stress;
to form a composite having a reduced electrical resistance.

25. A composite produced according to the process of claim 12.

26. An electrically conductive material, an electrically shielding material or a material which conducts away electrostatic charges comprising the composite according to claim 25.

27. A composite produced according to the process of claim 24.

28. An electrically conductive material, an electrically shielding material or a material which conducts away electrostatic charges comprising the composite according to claim 27.
